(19) United States
(12) Patent Application Publication
(10) Pub. No.: US 2015/0067242 A1
(43) Pub. Date: Mar. 5, 2015

(54) INFORMATION PROCESSING DEVICE

(71) Applicant: KYOCERA Document Solutions Inc., Osaka (JP)

(72) Inventor: Akihiko Kuroki, Osaka (JP)

(21) Appl. No.: 14/463,503

(22) Filed: Aug. 19, 2014

(30) Foreign Application Priority Data
Aug. 28, 2013 (JP) 2013-177255

(51) Int. Cl. G06F 12/02; G06F 9/44

(52) U.S. Cl. CPC G06F 12/0246; G06F 9/4406
USPC 711/103

(57) ABSTRACT

In an information processing device, a NAND flash memory has a first area and a second area in each of which a boot code is stored. A processor expands the boot code from the NAND flash memory onto the random access memory, executes the expanded boot code, and rewrites the boot code in the first area and the boot code in the second area at different timings based on the number of times that boot is performed. A boot area setting portion sets access destination of the processor at boot to either the first area or the second area. A controller controls the boot area setting portion so that the access destination of the processor at boot is switched alternately between the first area and the second area at every predetermined number of times that boot is performed.

### INCORPORATION BY REFERENCE

This application is based upon and claims the benefit of priority from the corresponding Japanese Patent Application No. 2013-177255 filed on Aug. 28, 2013, the entire contents of which are incorporated herein by reference.

### BACKGROUND

The present disclosure relates to an information processing device.

One information processing device stores a boot code in a NAND flash memory in advance, and, at boot, expands the boot code from the NAND flash memory onto a RAM and performs a boot process by executing the boot code on the RAM.

### SUMMARY

An information processing device according to one aspect of the present disclosure includes a NAND flash memory, a random access memory, a processor, a boot area setting portion, and a controller. The NAND flash memory has a first area and a second area in each of which a boot code is stored. The processor expands the boot code from the NAND flash memory onto the random access memory, executes the expanded boot code, and rewrites the boot code in the first area and the boot code in the second area at different timings based on the number of times that boot is performed. The boot area setting portion sets access destination of the processor at boot to either the first area or the second area. The controller controls the boot area setting portion so that the access destination of the processor at boot is switched alternately between the first area and the second area at every predetermined number of times that boot is performed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing the structure of the information processing device in the embodiment of the present disclosure.

FIG. 2 is a flowchart for explaining the operation of the information processing device shown in FIG. 1.

### DETAILED DESCRIPTION

The following describes an embodiment of the present disclosure with reference to the drawings.

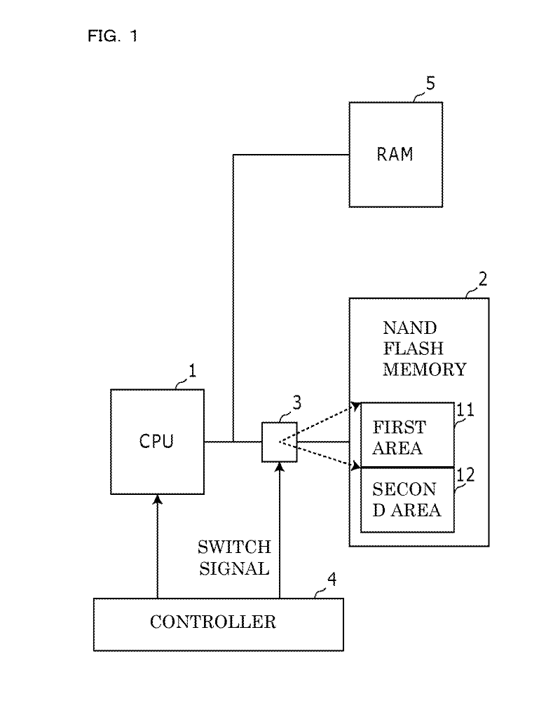

FIG. 1 is a block diagram showing the structure of the information processing device in the embodiment of the present disclosure.

The information processing device shown in FIG. 1 includes a CPU (Central Processing Unit) 1, a NAND flash memory 2, a boot area setting portion 3, a controller 4, and a RAM 5.

Meanwhile, there is known a system adopting a boot process for which a boot code is stored in the NAND flash memory 2 in advance, and, at boot, the boot code is expanded from the NAND flash memory 2 onto the RAM 5, and the boot process is performed by executing the boot code on the RAM 5 (hereinafter, the boot process is referred to as “NAND boot”). Here, during a deep sleep period, when the system is activated on a regular basis due to necessity, the read access to a boot sector in the NAND flash memory 2 frequently occurs, and a read-disturb, which is unique to the NAND flash memory 2, occurs and damages the boot code in the boot sector. To prevent the read-disturb from damaging the boot code, rewriting the boot code may be considered. However, when rewriting the boot code fails, the system cannot be activated. On the other hand, the information processing device of the embodiment of the present disclosure ensures that the rewriting of the boot code for the NAND boot system is performed safely.

The CPU 1 is a processor that, at boot, expands the boot code from the NAND flash memory 2 onto the RAM 5 and executes the expanded boot code.

In the NAND flash memory 2, a same boot code is stored in both a first area 11 and a second area 12. The first area 11 and the second area 12 are, for example, boot areas composed of two banks that are different from each other.

The CPU 1 rewrites the boot code in the first area 11 and the boot code in the second area 12 at different timings based on the number of times that the boot is performed.

The boot area setting portion 3 sets the access destination of the CPU 1 at boot to either the first area 11 or the second area 12, in accordance with a switch signal from the controller 4.

The controller 4 manages the transfer between the normal operation state and the deep sleep state. Specifically, the controller 4 turns off the power sources of the CPU 1, RAM 5 and the like at the start of the deep sleep. In addition, during the deep sleep, the controller 4 turns on the power sources of the CPU 1, RAM 5 and the like on a regular basis (for example, at every three seconds) and allows for the CPU 1 to execute the boot code for a predetermined process. And after the completion of the predetermined process in which the boot code was executed, the controller 4 turns off the power sources of the CPU 1, RAM 5 and the like.

The above-mentioned predetermined process may be, for example, a process which is executed to confirm whether or not an elapsed time from a predetermined timing has reached a predetermined time. Such a process is executed, for example, when a network protocol requires that a data transmission is performed at every predetermined time on a regular basis.

In addition, the controller 4 controls the boot area setting portion 3 so that the access destination of the processor at boot is switched alternately between the first area 11 and the second area 12 at every predetermined number of times that the boot is performed.

Furthermore, in the present embodiment, the controller 4 rewrites the boot code in the first area 11 by using the boot code in the second area 12, and rewrites the boot code in the second area 12 by using the boot code in the first area 11.

Furthermore, in the present embodiment, the controller 4 includes: a first boot number counter for the boot code in the first area 11; and a second boot number counter for the boot code in the second area 12. The controller 4 increments the first boot number counter each time a boot is performed by executing the boot code in the first area 11, and increments the second boot number counter each time a boot is performed by executing the boot code in the second area 12. The CPU 1 rewrites the boot code in the first area 11 when the count number of the first boot number counter reaches a predetermined number, and rewrites the boot code in the second area 12 when the count number of the second boot number counter reaches the predetermined number.

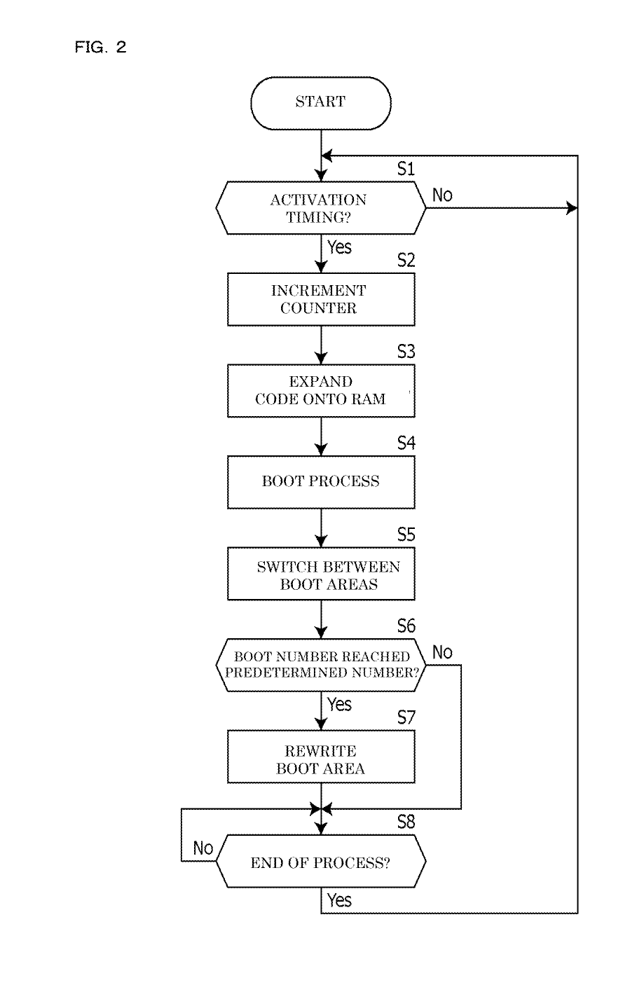

Next, the operation of the information processing device is described. FIG. 2 is a flowchart for explaining the operation of the information processing device shown in FIG. 1.

When the activation timing comes (for example, at every three seconds) (step S1), the controller 4 turns on the power sources of the CPU 1, RAM 5 and the like. In addition, the controller 4 increments a boot number counter for a currently selected boot area selected from between the first area 11 and the second area 12 (step S2).

On the other hand, after the power source of the CPU 1 is turned on, the CPU 1 reads a boot code from the reset vector. In doing this, the boot area setting portion 3 selects the currently selected boot area, and the CPU 1 reads a boot code from the currently selected boot area, expands the boot code onto the RAM 5 (step S3), and executes the boot code (step S4). After the completion of this boot process, the CPU 1 starts executing the above-described predetermined process.

After the completion of the boot process, the controller 4 supplies the switch signal to the boot area setting portion 3 to switch between boot areas (step S5). This ensures that a boot code in a boot area, which is different from the boot area used at this time, is used in the next boot.

The CPU 1 determines, based on the boot code, whether or not the count number held by the boot number counter for the boot area used at this time is equal to a predetermined number (for example, 100,000 times as the number of times that the boot was performed) or more (step S6). Here, when the count number of the boot number counter for the boot area used at this time is equal to the predetermined number or more, the CPU 1 executes rewriting of the boot code in the boot area (namely, refresh operation) (step S7), and resets the count number of the boot number counter to zero.

Subsequently, after the above-described predetermined process ends (step S8), the controller 4 turns off the power sources of the CPU 1, RAM 5 and the like, return the process to step S1, and waits until the next activation timing.

It is noted that although in this example, switching between the boot areas is performed each time the boot process is performed, switching between the boot areas may be performed each time the boot process is performed a plurality of times.

As described above, according to the present embodiment, the boot area setting portion 3 sets the access destination of the CPU 1 at boot to either of the first area 11 and the second area 12 that are provided in the NAND flash memory 2. In addition, the controller 4 controls the boot area setting portion 3 so that the access destination of the CPU 1 at boot is switched between the first area 11 and the second area 12 alternately at every predetermined number of times that the boot is performed. The CPU 1 rewrites the boot code in the first area 11 and the boot code in the second area 12 at different timings based on the number of times that the boot is performed.

With this structure, even if a rewriting of a boot code in one boot area results in a failure, the next boot can be performed by executing a boot code in the other boot area, and the boot code in one boot area that failed to be rewritten can be repaired by using the boot code in the other boot area. Accordingly, rewriting of the boot code for the NAND boot system can be performed safely.

It is noted that the above-described embodiment is a suitable example of the present disclosure, but the present disclosure is not limited to the example. Various modifications and variations should be possible within the scope of the present disclosure.

The present disclosure is applicable to, for example, electronic devices adopting the NAND boot.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing device comprising:
a NAND flash memory having a first area and a second area in each of which a boot code is stored;
a random access memory;
a processor configured to expand the boot code from the NAND flash memory onto the random access memory, execute the expanded boot code, and rewrite the boot code in the first area and the boot code in the second area at different timings based on the number of times that boot is performed;
a boot area setting portion configured to set access destination of the processor at boot to either the first area or the second area; and
a controller configured to control the boot area setting portion so that the access destination of the processor at boot is switched alternately between the first area and the second area at every predetermined number of times that boot is performed.

2. The information processing device according to claim 1, wherein
the processor rewrites the boot code in the first area by using the boot code in the second area, and rewrites the boot code in the second area by using the boot code in the first area.

3. The information processing device according to claim 1, wherein
the controller increments a first boot number counter each time boot is performed by executing the boot code in the first area, and increments a second boot number counter each time boot is performed by executing the boot code in the second area, and
the processor rewrites the boot code in the first area when a count number of the first boot number counter reaches a predetermined number, and rewrites the boot code in the second area when a count number of the second boot number counter reaches the predetermined number.

4. The information processing device according to claim 1, wherein
the controller turns off power sources of the processor and the random access memory at a start of a deep sleep, and during the deep sleep, the controller turns on the power sources of the processor and the random access memory on a regular basis and allows for the processor to execute the boot code for a predetermined process, and after completion of the predetermined process in which the boot code was executed, the controller turns off the power sources of the processor and the random access memory.
